(19) United States
(12) Patent Application Publication
(10) Pub. No.: US 2020/0065418 A1
(43) Pub. Date: Feb. 27, 2020

(54) CONTENT RECEPTION VISUALIZATION

(71) Applicant: International Business Machines Corporation, Armonk, NY (US)

(72) Inventors: Kelley Anders, East New Market, MD (US); Liam S. Harpur, Dublin (IE); Jeremy R. Fox, Georgetown, TX (US); Jonathan Dunne, Dungarvan (IE)

(21) Appl. No.: 16/106,991

(22) Filed: Aug. 21, 2018

(51) Int. Cl. G06F 17/30

(52) U.S. Cl. CPC G06F 17/30696; G06F 17/30828; G06F 17/30867; G06F 17/30616

(57) ABSTRACT

Methods and systems of outputting feedback indicators for content are described. A processor may receive a request from a device. The request may be a request for content. The processor may generate feedback data that comprises a feedback indicator assigned to a segment of the content. The feedback indicator may be based on feedbacks from a plurality of users that consumed the segment of the content. The processor may output the content on the device. The processor may detect an occurrence of the segment during the output of the content. The processor may, in response to the occurrence of the segment, output the feedback indicator assigned to the segment on the device.

### FIELD

The present application relates generally to computers, and computer applications, and more particularly to computer-implemented methods and systems relating to content sharing platforms.

### BACKGROUND

A plurality of users may view a piece of content on a network, such as watch a video on the Internet via video screaming platforms. An owner of the content may wish to obtain feedback from users who are viewing the content. Feedback of the content may become explicit to the owner when two or more users interact with each other, such as when a first user responds to a comment by a second user. In some examples, a lack of interactions among the users viewing the content may provide an undesirable amount of feedback on the content to the owner.

### SUMMARY

In some examples, a method of outputting feedback indicators for content is generally described. The method may comprise receiving, by a processor, a request from a device, where the request may be a request for content. The method may further comprise generating, by the processor, feedback data that comprises a feedback indicator assigned to a segment of the content. The feedback indicator may be based on feedbacks from a plurality of users that consumed the segment of the content. The method may further comprise outputting, by the processor, the content on the device. The method may further comprise detecting, by the processor, an occurrence of the segment during the output of the content. The method may further comprise in response to the occurrence of the segment, outputting, by the processor, the feedback indicator assigned to the segment on the device.

In some examples, a system of outputting feedback indicators for content is generally described. The system may comprise a memory configured to store assignments of a set of feedback indicators to the plurality of content. The system may further comprise a processor configured to be in communication with the memory. The processor may be configured to receive a request from a device, where the request may be a request for content. The processor may be further configured to generate feedback data based on the stored assignments. The feedback data may comprise a feedback indicator assigned to a segment of the content. The feedback indicator may be based on feedbacks from a plurality of users that consumed the segment of the content. The processor may be further configured to output the content on the device. The processor may be further configured to detect an occurrence of the segment during the output of the content. The processor may be further configured to, in response to the occurrence of the segment, output the feedback indicator assigned to the segment on the device.

In some examples, a computer program product of outputting feedback indicators for content is generally described. The computer program product may include a computer readable storage medium having program instructions embodied therewith. The program instructions may be executable by a processing element of a device to cause the device to perform one or more methods described herein.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 illustrates an example computer system in one embodiment that can be utilized to implement content reception visualization in one embodiment.

FIG. 2 illustrates a flow diagram relating to content reception visualization in one embodiment.

FIG. 3 illustrates a schematic of an example computer or processing system that may implement content reception visualization in one embodiment.

FIG. 4 depicts a cloud computing environment according to an embodiment of the present invention.

FIG. 5 depicts abstraction model layers according to an embodiment of the present invention.

### DETAILED DESCRIPTION

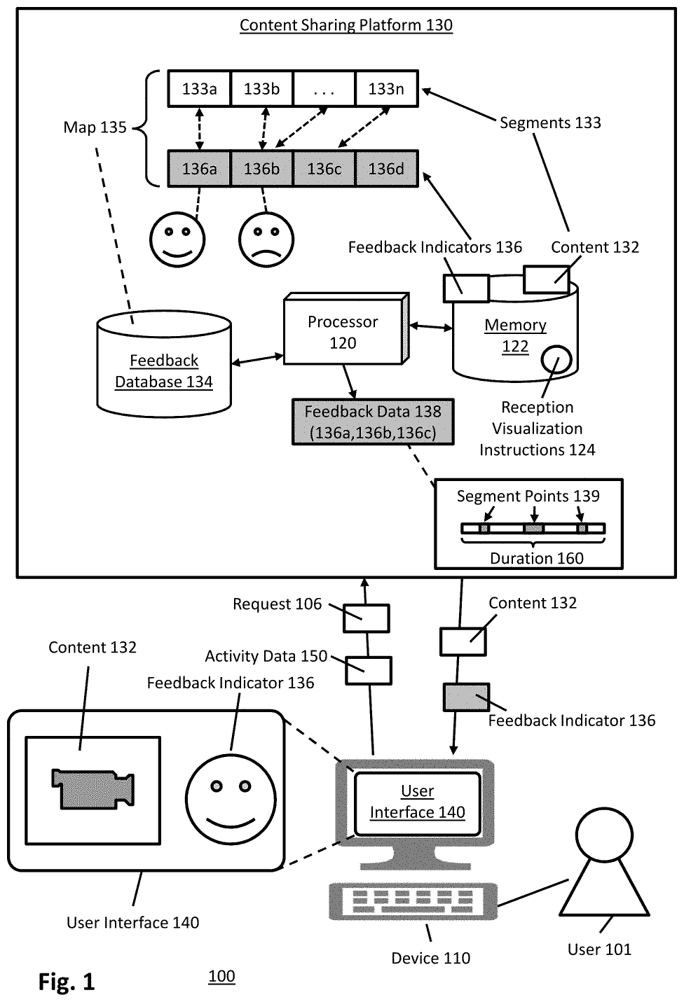

A system in accordance with the present disclosure (e.g., a system 100 shown in FIG. 1) may visualize the reception of one or more segments of a plurality of content by displaying an avatar, where the avatar may be based on an analysis of comments and feedback provided by a plurality of users that have consumed the segments of the content. The system 100 may output one or more avatars when a user is viewing the content. The outputted avatars may be customized and may represent feedback on the content being viewed, such as emotions, reception, one or more words or phrases, and/or other types of feedback. By displaying the avatars, the system 100 may provide a collaborative perspective to the user viewing the content, such as, showing real-time feedback on different segments of the content to simulate a collaborative environment as if the user is viewing the content with other users. By outputting the avatars while the user is viewing of the content, the user may also present his or her own avatar, such that an interaction between the user and other users may occur. The owner of the content may view the interactions, such as by viewing the outputted avatars, to obtain feedback on the content. Further, the user may view the avatar while viewing the content, such that it may be unnecessary for the user to navigate to another section of a user interface to view feedback on the content. Furthermore, by showing the avatar instantaneously, the user viewing the content may be aware of different receptions on different segments of the content without the need to navigate to a feedback section to search for feedback on particular segments. Hence, the system 100 may improve a content sharing platform by adding the feature of visualizing content reception in real-time, which enhances user experience, provides an additional application for content owners to obtain a desirable amount of feedback from users, and reduces processing time and power of devices allocated to process comment handling in the content sharing platform. For example, an amount of resources, such as devices and personnel, to review, filter, and categorize comments and feedbacks of content may be reduced by implementing the system 100.

FIG. 1 illustrates an example computer system 100 that can be utilized to implement content reception visualization, arranged in accordance with at least some embodiments described herein. In some examples, the system 100 may be implemented with a computer device 110 (“device 110”) and/or a content sharing platform 130. The device 110 may be a computer, a laptop, a cellular phone, a smartphone, a wearable device, and/or other types of device, that may include a display or a screen, and may be controlled or operated by a user 101. The content sharing platform 130 may be a system of hardware components including servers, computing devices, storage mediums, and/or other hardware components. The content sharing platform 130 may be associated with content sharing applications such as online video streaming applications, social media applications, and/or other applications that may include a feature of content sharing. The content sharing platform 130 may include a processor 120 and a memory 122 configured to be in communication with each other. The content sharing platform 130 may further include a feedback database 134, which may be stored in the memory 122 or stored in another memory different from the memory 122. In some examples, the feedback database 134 may be stored in a memory separated from the content sharing platform 130 but may be accessible by the processor 120. The processor 120 may be a server of the content sharing platform 130, or may be a central processing unit of a device among various hardware components of the content sharing platform 130. In some examples, the processor 120 may be configured to control operations of the memory 122 and/or other components of the content sharing platform. In some examples, the content sharing platform 130 may include additional hardware components, such as programmable logic devices, microcontrollers, memory devices, and/or other hardware components, that may be configured to perform respective tasks of the methods described in the present disclosure. In some examples, the processor 120 may be configured to execute software modules that include instructions to perform each respective task of the methods described in the present disclosure. In some examples, the processor 120 and/or the memory 122 may each be resources of a cloud computing platform.

The memory 122 may be configured to selectively store instructions executable by the processor 120. For example, in one embodiment, the memory 122 may store a set of reception visualization instructions 124 (herein “instructions 124”), where the instructions 124 may include instructions, such as executable code, related to natural language processing, noise detection and classification, keyboard monitoring, comment handling, and/or other algorithms or techniques, which may implement the system 100. The processor 120 may be configured to execute one or more portions of the instructions 124 in order to facilitate implementation of the system 100. In some examples, the instructions 124 may be packaged as a standalone application that may be installed on the computer device implementing the system 100, such that the instructions 124 may be executed by the processor 120 to implement the system 100. In some examples, the instructions 124 may be stored in a programmable hardware component that may be embedded as part of the processor 120.

In some examples, at least a portion of the instructions 124 may be distributed by the content sharing platform 130 to the device 110, such that the distributed portion may be installed as a plug-in to a browser, or a plug-in to an application distributed by the content sharing platform 130. In an example, when the user 101 uses the device 110 to run a browser, and enters a web address of a webpage of the content sharing platform 130, the device 110 may execute the distributed plug-in in order to execute the portion of the instructions 124. In another example, an application distributed by the content sharing platform 130 may be installed on the device 110, such that an execution of the application may trigger an execution of the distributed plug-in including the portion of the instructions 124.

The memory 122 may be further configured to store feedback indicators 136 (including 136a, 136b, 136c, 136d). Each feedback indicator 136 may be an avatar that may be displayed on a user interface 140 as a static image or an animated image, where the user interface 140 may be displayed within a browser or an application of the content sharing platform 130. For example, a feedback indicator 136 may be a smiley face, a sad face, an animated figure dancing, a text bubble including words and/or phrases, a shape, and/or other images.

The memory 122 may be further configured to store at least one piece of content, such as content 132, that may be distributed or outputted by the content sharing platform. The content stored in memory 122 may be uploaded, or provided, to the content sharing platform 130 by different users or entities. The content stored in the memory 122 may include digital media such as films, television programs, user-generated videos, and/or other digital media. Each piece of content may include at least one segment 133 (including 133a, 133b, . . . , 133n), where each segment may be of a different duration. For example, if the content 132 is a video, each segment 133 of the content 132 may be of a different time duration, such as 10 seconds, thirty seconds, one minute, or other time periods. In some examples, each segment 133 may correspond to an event being shown in the content 132, such as a pet performing a trick, a musical performance, a person saying a particular phrase, and/or other events.

The feedback database 134 may include a map 135, where the map 135 may indicate mappings between the feedback indicators 136 stored in the memory 122 and segments of contents that may be stored in memory 122. In the example shown in FIG. 1, the map 135 may indicate that segment 133a of the content 132 is mapped to the feedback indicator 136a, segment 133b of the content 132 is mapped to the feedback indicator 136b, and segment 133n of the content 132 is mapped to the feedback indicator 136c. In some examples, a segment may be mapped to more than one feedback indicators, and more than one segments may be mapped to one feedback indicator.

The feedback database 134 may further include historical data such as historical feedback from a plurality of users of the content sharing platform 130, and may include associations between the historical data and the segments 133 of the content 132. For example, the feedback database 134 may include entries indicating a number of positive feedbacks and a number of negative feedbacks for each segment 133 of the content 132.

In an example, the processor 120 may be configured to generate the map 135 by assigning the feedback indicators 136 to the segments 133 of the content 132. In order to assign the feedback indicators 136 to the segments 133, the processor 120 may analyze the historical data in the feedback database 134 to determine if the historical data complies with particular conditions. For example, the processor 120 may determine that a ratio of positive feedbacks to negative feedbacks for the segment 133a exceeds a threshold (the threshold may be defined in instructions 124) and, in response, may assign the segment 133a to a positive feedback indicator (which in the example in FIG. 1, is feedback indicator 136a), such as an image of a smiley face or thumbs up. If the processor 120 determines that a ratio of positive feedbacks to negative feedbacks for the segment 133a does not exceed the threshold, the processor 120 may assign the segment 133a to a negative feedback indicator. In some examples, the processor 120 may analyze the historical data using natural language processing, and may assign the feedback indicators 136 based on the natural language processing analysis. For example, the processor 120 may identify words belonging to different categories, such as positive words and negative words, among the historical data. The processor 120 may determine an appropriate feedback indicator 136 that corresponds to the positive or negative words. For example, a smiley face may correspond to positive words such as “glad”, “happy”, “joy”, whereas a sad face may correspond to negative words such as “sad”, “sorry”.

As new feedbacks are being input by different users for each content stored in memory 122, the processor 120 may continue to update the assignments of feedback indicators 136 to different segments of contents, such that the feedback database 134 may be continuously updated. The processor 120 may monitor any changes of feedback indicator assignment that may be needed. For example, if the segment 133a is assigned to a positive feedback indicator 136a but as time progresses, the segment 133a has more negative feedbacks than positive feedbacks (e.g., a change of tone among the feedback from users), the processor 120 may reassign a negative feedback indicator (e.g., feedback indicator 136b) to the segment 133a. In another example, the instructions 124 may indicate a tone change threshold. The processor 120 may determine whether to change the assignment of feedback indicators based on the tone change threshold. The processor 120 may analyze all comments, or a group of most recent comments, to determine a presence of a tone change. For example, the instructions 124 may indicate a tone change threshold of 40%, such if three out of ten recent comments are negative (30%), the processor 120 may not change the assignment of a positive feedback indicator, but if five out of ten recent comments are negative (50%), the processor 120 may change the assignment of a positive feedback indicator to a negative feedback indicator.

In some examples, the historical feedback by users may be represented as probability distributions in order for the processor 120 to perform various analyses to assign feedback indicators 136 to segments of contents. For example, when feedback from each user carries equal weight or importance, the feedback by the users may be represented as a normal distribution. In other examples, depending on a desired implementation of the system 100, the feedback from the users may be represented as other probability distributions such as lognormal, Pareto, Weibull, and/or other distributions. In some examples, the instructions 124 may include instructions to assign weights to particular groups of users. For examples, feedback on an educational video from a group of teachers may be given a higher weight than feedback provided by a group of students.

In some examples, the processor 120 may implement a scoring mechanism during implementation of the system 100. The scoring mechanism may be used to control the feedbacks of the content. For example, an event where two users are using a comments section to argue against each other may cause a significant number of negative feedbacks to appear, but may be irrelevant to the content. The processor 120 may implement a scoring mechanism to give such comments a low score and subsequently, filter comments that have low scores. Thus, an appropriate set of comments excluding irrelevant comments may be identified and used to assign feedback indicators 136 to segments of the content. In some examples, the scores from the scoring mechanism may be used as data points in a distribution of scores, such that the processor 120 may identify any abnormal data points that may seem significantly different from the distribution and filter out the questionable comments.

In an example, an owner of the content 132 may post the content 132 and specify that the content 132 be outputted with the reception visualization feature that may be implemented by the system 100. The processor 120 may analyze activities of viewers of the content 132, such as by executing a Gaussian graph analysis of activities of the users viewing the content 132. For example, the processor 120 may analyze data from webcams, microphones, keyboards, existing comments and feedback on the content 132, and/or other activities. The processor 120 may determine a cluster of behavior that has a correlation with a particular segment of the content 132. For example, based on the activities detected from the microphones of the users, the processor 120 may detect that a majority of users have laughed during a particular segment of the content 132. Thus, the processor 120 may assign a feedback indicator 136 that may depict a laughing avatar to the particular segment of the content 132.

Upon assigning the feedback indicators 136 to the segments 133 of the content 132, the content sharing platform 130 may output the content 132 with the reception visualization feature, where the feedback indicators 136 may be outputted during output of different segments of the content 132. In an example shown in FIG. 1, the user 101 may use the device 110 to send a request 106 for the content 132. The processor 120 may receive the request 106 and, in response, may generate feedback data 138, where the feedback data 138 may include feedback indicators 136 that are mapped to segments 133 of the content 132. For example, the memory 122 may store a set of feedback indicators 136, but only a subset of the feedback indicators 136 may be mapped to segments 133 of the content 132. The processor 120 may generate the feedback data 138 for the content 132 by analyzing the map 135. The processor 120, based on the analysis of the map 135, may identify the subset of feedback indicators 136 that are mapped to segments 133 of the content 132. The processor 120 may aggregate the identified feedback indicators 136 to generate the feedback data 138 of the content 132. The processor 120 may send the feedback data 138 to the device 110 and may also output the content 132 on the device 110. In some examples, by generating the feedback data 138 prior to outputting the content 132, the processor 120 may promptly identify feedback indicators 136 mapped to the segments 133 by searching among feedback data 138 instead of accessing the feedback database 134.

In some examples, the feedback data 138 may further include a set of segment points 139, where each segment point 139 may represent a position of a segment among the content 132. For example, the content 132 may span a duration 160, which may be two minutes. The segment points 139 may indicate that a first segment assigned with a feedback indicator may be at the thirty-second mark of the two minute duration, and a second segment assigned with a feedback indicator may be at the one-minute mark of the two minute duration.

Upon generating the feedback data 138, the processor 120 may output the content 132 on the device 110. In some examples, output of the content 132 may include streaming the content 132 on the device 110 through a network, such as the Internet. In an example, as the content 132 is being outputted by the processor 120, the processor 120 may track a progress of the output of the content 132, such as detecting whether the output of the content 132 has reached a segment point 139. A progress where the output of the content 132 reaches a segment point 139 may include an occurrence, or output, of a corresponding segment. For example, a segment point at the thirty-second mark may be a start of an occurrence of a pet performing a trick. In response to detecting the occurrence of the segment, the processor 120 may output a feedback indicator 136 among the feedback data 138 that is assigned to the occurred segment. For example, in response to detecting the output of the segment showing the pet performing the trick, the processor 120 may output a smiley face (feedback indicator 136a) on the user interface 140 to show the user 101 that the segment has been well received by a majority of users who consumed the content 132. In some examples, the processor 120 may embed the feedback indicators 136 assigned to each segment 133 at corresponding segment points 139, and may output the content 132 with the embedded feedback indicators. Thus, an output of the content 132 may include outputting the embedded feedback indicators 136 automatically when a segment occurs. The output of the feedback indicators 136 may overlap the content 132, or separate from the content 132, on the user interface 140 depending on a desired implementation of system 100 and/or depending on settings configured by the user 101 or the content sharing platform 130.

In another example, as the content 132 is being outputted by the processor 120, the processor 120 may track a progress of the output of the content 132 by detecting activities of the user 101 viewing the content 132. For example, when the user 101 is viewing the segment where the pet is performing the trick, the user 101 may begin to move the user interface 140 to a comments section, such as by using a keyboard or a mouse. The processor 120 may obtain activity data 150 indicating such movements, and the processor 120 may determine that the user 101 may want to view comments relating to the segment being outputted. The processor 120 may identify the segment that is being viewed by the user 101 during the movement indicated by the activity data 150 and, in response, may output a feedback indicator 136 among the feedback data 138 that is assigned to the segment.

In some examples, the device 110 may monitor the activities of the user 101 to generate the activity data 150. The device 110 may further perform the analysis on activity data 150 and may provide results (e.g., which segment is the user 101 viewing, and the user 101 is moving towards the comments section) of the analysis to the processor 120, such that the processor 120 may automatically determine whether to output the feedback indicators in response to receiving the results.

In some examples, the processor 120 may output more than one feedback indicators on the user interface 140. For example, more than one smiley faces may be outputted to indicate a degree of positive reception of the segment currently being outputted. The user 101 or the content sharing platform 130 may configure an amount of feedback indicators to be displayed on the user interface 140.

As such, the processor 120 may automatically provide visualized feedback on the segment to the user 101 without having the user 101 search for feedbacks on the segment. Further, by outputting the feedback indicators 136 during the output of the content 132, the system 100 may provide a cue to the user 101 viewing the content 132 that there may be a segment of interest, in order to increase a chance where the user 101 may provide his or her own feedback on the segment. Thus, the owner of the content 132 may use the reception visualization feature to attempt to obtain more feedbacks on the content 132. The system 100 may continue to output feedback indicators 136 for different users, obtain new feedback, update the feedback database 134 and feedback indicator assignments, to facilitate a continuous flow of commentary on different segments of the content 132.

In another example, the processor 120 may further send a set of predefined feedback to the device 110 during the output of the content 132 and feedback indicators 136. For example, the processor 120 may output a smiley face as a feedback indicator for a segment, and may also output a thumbs up, a laughing face, that may be selectable by the user 101 using the device 110. Thus, the user 101 may view the feedback indicator 136 and may also view the selectable predefined feedback, and may respond to the outputted feedback indicator by selecting one of the predefined feedback. In some examples, the predefined feedback provided to the user 101 may be based on an analysis of historical feedbacks. For example, if a majority of feedbacks on the segment are positive feedbacks, the processor 120 may provide a set of predefined positive feedbacks.

In some examples, the system 100 may predict and monitor developments of interactions between users by analyzing historical comments and feedback in order to assign feedback indicators 136 to different segments. The system 100 may determine, for a piece of content in a location (e.g., a forum, a geographical location, a blog, and/or other types of locations), whether a thread of comments may be developed between a plurality of users. For example, a car video being posted on a car forum may be more likely to have a thread of comments than when the car video is being posted in a blog about the stock market. Further, the system 100 may determine probabilities where each user may respond to particular comments and response time. For example, a first user that typically responds to comments relating to cars within a minute of seeing a new comment may be more likely participate in a thread of comments relating to the car video than a second user that has never responded to comments on car videos. Thus, the system 100 may provide a predefined set of feedback indicators to the first user such that the first user may easily respond to any feedback indicator being outputted with the car video. Also, the system 100 may not present predefined feedback indicators to the second user knowing that the second user is not likely to respond, which may reduce processing time and power of the system 100. As a result, the system 100 may analyze historical comments and feedback from different users, at different locations, to predict occurrences and developments of threads of comments for different segments of contents. The system 100, based on the predicted occurrences and developments of the threads of comments, may assign feedback indicators 136 to the segments and may present different predefined feedback indicators to the users viewing the contents.

In some examples, the system 100 may further be implemented to detect automatic comments that may be generated by computer devices without user input. For example, a user may program a computer device to automatically generate augmented, or random, comments and feedback to populate a thread of comments for content. The system 100 may apply various algorithms, such as natural language processing algorithms, to determine a probability of each comment being an augmented comment. In another example, the system 100 may determine an amount of interaction initiated by each comment. For example, if a first comment has no replies and a second comment has ten replies, then the system 100 may determine that the first comment may have a high probability of being an augmented comment than the second comment. Further, the system 100 may analyze whether a username associated with each comment is also associated with similar comments. For example, if a username is associated with ten comments and the ten comments are very similar in various attributes (e.g., context, tone, lexicon, length, and/or other attributes), then the system 100 may determine that any comment associated with the username may have a high probability of being an augmented comment. The system 100 may notify owners of contents about comments that may be augmented comments, and may filter out the augmented comments based on configurations set by the owners of the contents. In some examples, the notification to the owners may include using hashtag or mention functionalities provided by the content sharing platform 130. For example, an owner may configure the system 100 to filter out comments that have more than 70% chance of being augmented comments.

The user interface 140 outputted by the content sharing platform 130 may further include features such as indicating timelines for the comment insertion, indicating where the comment should be inserted, indicating when the reception visualization feature is enabled, presenting options to location, timing, and properties of the content and feedback indicators being presented on the user interface 140, and/or other features.

In some examples, the processor 120 may be further configured to construct an expected trajectory of feedback. For example, if the first ten feedbacks on a segment of the content 132 are negative feedbacks, and the next twenty feedbacks are positive feedbacks, the processor 120 may predict that the segment of the content 132 may continue to receive positive feedbacks. In some examples, the processor 120 may analyze each new feedback one by one instead of waiting for a number of feedbacks to be received. For example, the processor 120 may identify a first positive word in a first feedback, and may assign a first score to the first word. The processor 120 may further identify a second positive word in a second feedback, and may assign a second score to the second word. The processor 120 may continue to identify words and assign scores as each feedback is being received, such that a trajectory (which may be represented as a distribution) may be constructed by the processor 120. Then, depending on the trajectory, the processor 120 may perform various analyses, as discussed above, to assign feedback indicators to different segments of content.

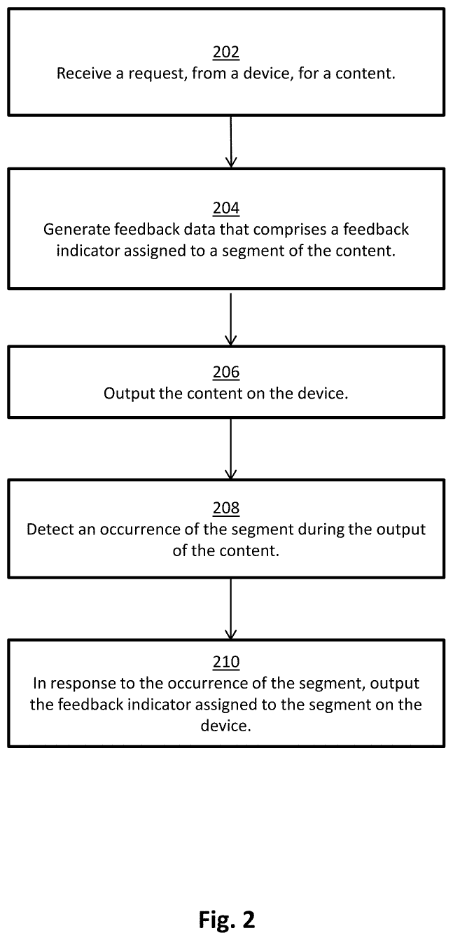

FIG. 2 illustrates a flow diagram relating to content reception visualization, arranged in accordance with at least some embodiments presented herein. The process in FIG. 2 may be implemented using, for example, computer system 100 discussed above. An example process may include one or more operations, actions, or functions as illustrated by one or more of blocks 202, 204, 206, 208, and/or 210. Although illustrated as discrete blocks, various blocks may be divided into additional blocks, combined into fewer blocks, eliminated, or performed in parallel, depending on the desired implementation.

Processing may begin at block 202, where a processor may receive a request from a device, where the request may be a request for content.

Processing may continue from block 202 to block 204. At block 204, the processor may generate feedback data that comprises a feedback indicator assigned to a segment of the content. The feedback indicator may be based on feedbacks from a plurality of users that consumed the segment of the content. The processor may generate the feedback data by identifying at least one feedback indicator assigned to at least one segment of the content.

Processing may continue from block 204 to block 206. At block 206, the processor may output the content on the device.

Processing may continue from block 206 to block 208. At block 208, the processor may detect an occurrence of the segment during the output of the content. The processor may detect the occurrence of the segment by detecting activities from at least one input devices connected to the device.

Processing may continue from block 208 to block 210. At block 210, in response to the occurrence of the segment, the processor may output the feedback indicator assigned to the segment on the device. The feedback indicator may be an avatar that represents feedbacks from at least a subset of the plurality of the users that consumed the segment. In some examples, the processor may further receive a new feedback corresponding to the segment from the device. The processor may update the feedbacks from the plurality of users that consumed the segment with the new feedback. The processor may further determine a compliance of the updated feedbacks with a condition. The processor may, in response to the updated feedbacks not in compliance with the condition, assign a new feedback indicator to the segment.

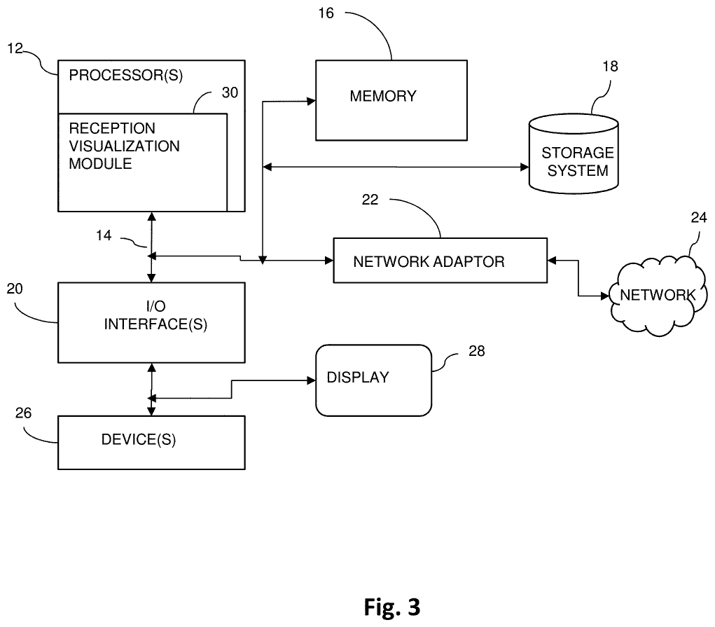

FIG. 3 illustrates a schematic of an example computer or processing system that may implement content reception visualization in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 3 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, supercomputers, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 30 (e.g., reception visualization module 30) that performs the methods described herein. The module 30 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

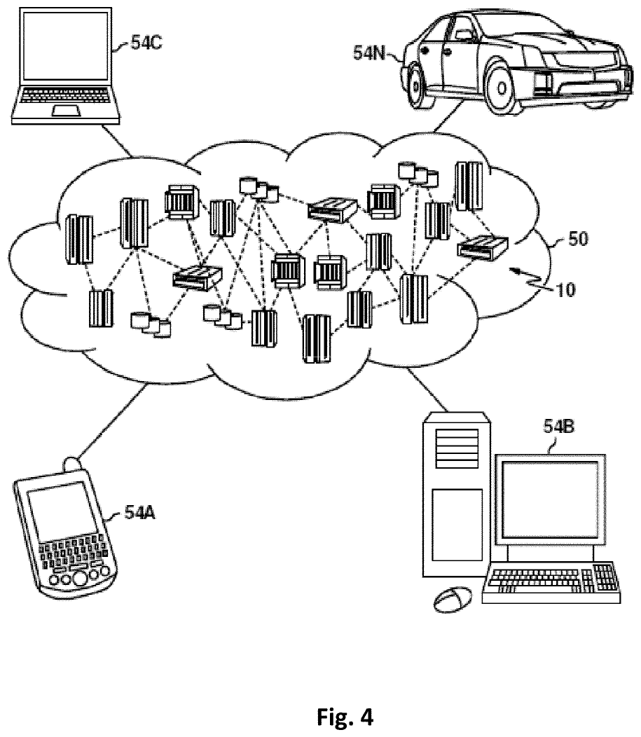

FIG. 4 depicts a cloud computing environment according to an embodiment of the present invention. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

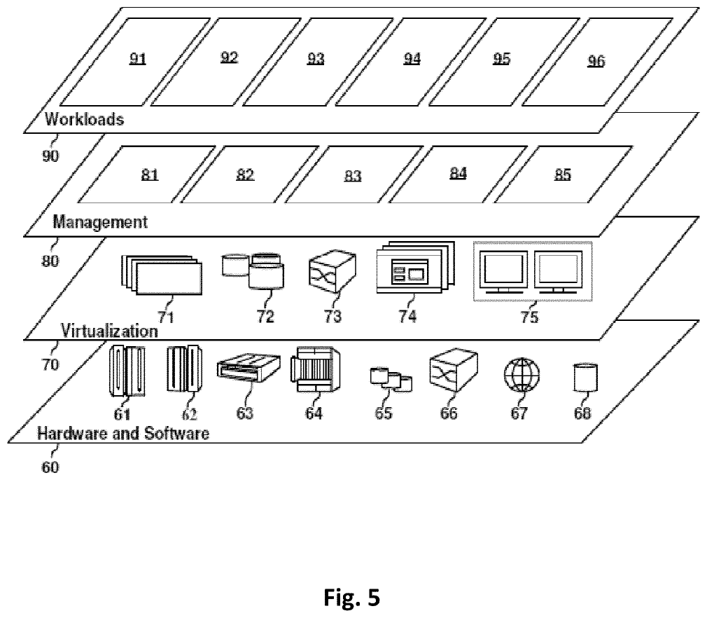

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

FIG. 5 depicts abstraction model layers according to an embodiment of the present invention. Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and content reception visualization 96.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
receiving, by a processor, a request from a device, wherein the request is a request for content;
generating, by the processor, feedback data that comprises a feedback indicator assigned to a segment of the content, wherein the feedback indicator is based on feedbacks from a plurality of users that consumed the segment of the content;
outputting, by the processor, the content on the device;
detecting, by the processor, an occurrence of the segment during the output of the content; and
in response to the occurrence of the segment, outputting, by the processor, the feedback indicator assigned to the segment on the device.

2. The computer-implemented method of claim 1, wherein generating the feedback data comprises:
in response to receiving the request, identifying, by the processor, at least one feedback indicator assigned to at least one segment of the content.

3. The computer-implemented method of claim 1, wherein outputting the feedback indicator includes displaying, by the processor, an avatar on the device, wherein the avatar represents feedbacks from at least a subset of the plurality of the users that consumed the segment.

4. The computer-implemented method of claim 1, further comprising:
receiving, by the processor, a new feedback corresponding to the segment from the device;
updating, by the processor, the feedbacks from the plurality of users that consumed the segment with the new feedback.

5. The computer-implemented method of claim 4, further comprising:
determining, by the processor, a compliance of the updated feedbacks with a condition; and
in response to determining that the updated feedbacks are not in compliance with the condition, assigning, by the processor, a new feedback indicator to the segment.

6. The computer-implemented method of claim 1, further comprising outputting, by the processor, at least one predefined feedback indicator on the device, wherein the at least one predefined feedback indicator is selectable by a user of the device to respond to the outputted feedback indicator.

7. The computer-implemented method of claim 1, wherein detecting the occurrence of the segment comprises detecting activities from at least one input device connected to the device.

8. The computer-implemented method of claim 1, further comprising:
identifying, by the processor, keywords from the feedbacks of the plurality of users that have consumed the segment; and
assigning, by the processor, the feedback indicator to the segment based on the identified keywords.

9. The computer-implemented method of claim 8, wherein the identified keywords comprises a first set of keywords of a first category and a second set of keywords of a second category, and the method further comprising:
determining, by the processor, a first amount of words among the first set of keywords;
determining, by the processor, a second amount of words among the second set of keywords;
determining, by the processor, that the first amount is greater than the second amount; and
assigning, by the processor, a feedback indicator of the first category to the segment.

10. A system comprising:
a memory device configured to store assignments of a set of feedback indicators to a plurality of content;
a hardware processor configured to be in communication with the memory, the hardware processor being configured to:
receive a request from a device, wherein the request is a request for content;
generate feedback data based on the stored assignments, wherein the feedback data comprises a feedback indicator assigned to a segment of the content, and the feedback indicator is based on feedbacks from a plurality of users that consumed the segment of the content;
output the content on the device;
detect an occurrence of the segment during the output of the content; and
in response to the occurrence of the segment, output the feedback indicator assigned to the segment on the device.

11. The system of claim 10, wherein the hardware processor is further configured to in response to the receipt of the request, identify at least one feedback indicator assigned to at least one segment of the content.

12. The system of claim 10, wherein the hardware processor is further configured to:
receive a new feedback corresponding to the segment from the device; and
update the feedbacks from the plurality of users that consumed the segment with the new feedback.

13. The system of claim 12, wherein the hardware processor is further configured to:
determine a compliance of the updated feedbacks with a condition;
in response to a determination that the updated feedbacks are not in compliance with the condition, assign a new feedback indicator to the segment; and
update the assignments stored in the memory based on the assignment of the new feedback indicator to the segment.

14. The system of claim 10, wherein the hardware processor is further configured to output at least one predefined feedback indicator on the device, wherein the at least one predefined feedback indicator is selectable by a user of the device to respond to the outputted feedback indicator.

15. The system of claim 10, wherein the hardware processor is further configured to:
identify keywords from the feedbacks of the plurality of users that have consumed the segment; and
assign the feedback indicator to the segment based on the identified keywords.

16. A computer program product of outputting feedback indicators for content, the computer program product comprising a computer readable storage medium having program instructions embodied therewith, the program instructions executable by a processing element of a first device to cause the first device to:
receive a request from a second device, wherein the request is a request for content;
generate feedback data that comprises a feedback indicator assigned to a segment of the content, wherein the feedback indicator is based on feedbacks from a plurality of users that consumed the segment of the content;
output the content on the second device;
detect an occurrence of the segment during the output of the content; and
in response to the occurrence of the segment, output the feedback indicator assigned to the segment on the second device.

17. The computer program product of claim 16, wherein the program instructions are further executable by the processing element of the first device to cause the first device to, in response to the receipt of the request, identify at least one feedback indicator assigned to at least one segment of the content.

18. The computer program product of claim 16, wherein the program instructions are further executable by the processing element of the first device to cause the first device to:
receive a new feedback corresponding to the segment from the second device;
update the feedbacks from the plurality of users that consumed the segment with the new feedback;
determine a compliance of the updated feedbacks with a condition; and
in response to a determination that the updated feedbacks are not in compliance with the condition, assign a new feedback indicator to the segment.

19. The computer program product of claim 16, wherein the program instructions are further executable by the processing element of the first device to cause the first device to output at least one predefined feedback indicator on the second device, wherein the at least one predefined feedback indicator is selectable by a user of the second device to respond to the outputted feedback indicator.

20. The computer program product of claim 16, wherein the program instructions are further executable by the processing element of the first device to cause the first device to:
identify keywords from the feedbacks of the plurality of users that have consumed the segment; and
assign the feedback indicator to the segment based on the identified keywords.
